(19) United States
(12) Patent Application Publication
(10) Pub. No.: US 2026/0281561 A1
(43) Pub. Date: Sep. 17, 2026

(54) INFORMATION PROCESSING DEVICE, INFORMATION PROCESSING METHOD, PROGRAM, IMAGE PROCESSING DEVICE, AND IMAGE PROCESSING METHOD

(71) Applicant: Sony Semiconductor Solutions Corporation, Kanagawa (JP)

(72) Inventor: Seichi OTSUKI, Kanagawa (JP)

(73) Assignee: Sony Semiconductor Solutions Corporation, Kanagawa (JP)

(21) Appl. No.: 19/469,398

(22) PCT Filed: Apr. 18, 2024
(86) PCT No.: PCT/JP2024/015476

§ 371 Date: Sep. 26, 2025

Related U.S. Application Data
(60) Provisional application No. 63/462,010, filed on Apr. 26, 2023.

(51) Int. Cl. H04N 23/71; H04N 23/12; H04N 23/76

(52) U.S. Cl. CPC H04N 23/71; H04N 23/12; H04N 23/76

(57) ABSTRACT

An information processing device includes: a sensor output estimation processing unit that estimates, on the basis of spectral reflectance information of a target subject and spectral information of a target light source, a sensor output that is output spectral information in a case where a spectral sensor has sensed the target subject irradiated with light from the target light source; and a derivation processor that obtains, as a computation algorithm of band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

### CROSS REFERENCE TO RELATED APPLICATIONS

This application claims priority to, and the benefit of, U.S. provisional patent application Ser. No. 63/462,010 filed on Apr. 26, 2023, incorporated herein by reference in its entirety.

### TECHNICAL FIELD

The present technology relates to an information processing device, an information processing method, a program, an image processing device, and an image processing method, and more particularly, relates to a technology for removing a light source component in a spectral camera that obtains spectral information of a subject by using a spectral sensor.

### BACKGROUND ART

A spectral sensor (multi-spectral sensor) for obtaining a plurality of narrow-band images that serves as wavelength characteristic analysis images for light from a subject, in other words, analysis images of spectral information (spectrum) of the subject, has been known, and an application for performing various analyses of the subject on the basis of the spectral information obtained by the spectral sensor, such as estimating a vegetation state of a plant or estimating a human skin condition on the basis of the plurality of narrow-band images, has been developed.

When the spectral information of the subject is obtained, spectral information of a light source that illuminates the subject becomes a noise component, and it is desirable to remove the noise component.

According to related arts, removal of the light source component is generally performed by a method of estimating the spectral information of the light source and dividing the estimated spectral information of the light source from the spectral information obtained by the spectral sensor (that is, a subject spectrum+a light source spectrum).

Note that PTL 1 below can be cited as a related art. PTL 1 below discloses a technology in which, in a lighted camera system, an image obtained by imaging a subject in a state where illumination light is not emitted is an unilluminated image, an image obtained by imaging the subject in a state where the illumination light is emitted is an illuminated image, and an ambient light component of the illuminated image is removed by using the unilluminated image.

### CITATION LIST

### Patent Literature

[PTL 1] JP 2014-122847A

### SUMMARY

### Technical Problem

Here, in a case where the spectral information of the light source is estimated as in the related art, there are many uncertain elements in the estimation of the spectral information of the light source, and an estimation error tends to easily occur. For this reason, in a case of the method using the spectral information of the light source estimated for removal of the light source component according to the related art, removal accuracy tends to decrease.

The present technology has been made in view of the above problems, and it is desirable to improve light source component removal accuracy in a spectral camera that obtains spectral information of a subject by using a spectral sensor.

### Solution to Problem

An information processing device according to an embodiment of the present technology includes: a sensor output estimation processing unit that estimates, on the basis of spectral reflectance information of a target subject and spectral information of a target light source, a sensor output that is output spectral information of a spectral sensor in a case where the spectral sensor has sensed the target subject irradiated with light from the target light source; and a derivation processing unit that obtains, as a computation algorithm of band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

With the configuration described above, the computation algorithm of the bandnarrowing processing is derived with the wavelength characteristic indicated by the spectral reflectance information of the target subject, which does not include the spectral information of the light source, as a target value. Therefore, as the spectral camera executes the band-narrowing processing by using the computation algorithm derived as described above, spectral information from which a light source component has been removed can be obtained as the post-band-narrowing spectral information if the light source and the subject are of assumed target types. That is, if the bandnarrowing processing is executed, the light source component is removed, so that it is not necessary to execute processing of estimating and removing the spectral information of the light source.

Furthermore, an image processing device according to an embodiment of the present technology includes: a spectral image generation unit that generates a narrow-band image for a larger number of wavelengths than the number of output wavelengths of a spectral sensor by executing band-narrowing processing based on an output of the spectral sensor using a computation algorithm obtained by an information processing device including a sensor output estimation processing unit that estimates, on the basis of spectral reflectance information of a target subject and spectral information of a target light source, a sensor output that is output spectral information of the spectral sensor in a case where the spectral sensor has sensed the target subject irradiated with light from the target light source, and a derivation processing unit that obtains, as the computation algorithm of the band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

The computation algorithm obtained by the information processing device as described above is a computation algorithm that can obtain spectral information from which a light source component has been removed without executing processing of removing the light source component by executing the band-narrowing processing using the computation algorithm if the light source and the subject are of assumed target types.

### BRIEF DESCRIPTION OF DRAWINGS

FIG. 1 is a block diagram illustrating a schematic configuration example of a target spectral camera according to an embodiment.

FIG. 2 is a diagram schematically illustrating a configuration example of a pixel array unit included in a spectral sensor.

FIG. 3 is an explanatory diagram of band-narrowing processing according to an embodiment.

FIG. 4 is a diagram illustrating a configuration example of an algorithm derivation system including an information processing device as an embodiment.

FIG. 5 is a diagram illustrating an example of subject spectral reflectance information.

FIG. 6 is a diagram illustrating an example of light source spectral information.

FIG. 7 is a block diagram illustrating a schematic configuration example of the information processing device as an embodiment.

FIG. 8 is a functional block diagram illustrating respective algorithm derivation functions of the information processing device as an embodiment.

FIG. 9 is a block diagram illustrating a schematic configuration example of an image processing device as an embodiment.

FIG. 10 is a block diagram illustrating a schematic configuration example of an image processing device as a first example according to a second embodiment.

FIG. 11 is a flowchart illustrating processing in the first example according to the second embodiment.

FIG. 12 is a block diagram illustrating a schematic configuration example of an image processing device as a second example according to the second embodiment.

FIG. 13 is a flowchart illustrating processing in the second example according to the second embodiment.

FIG. 14 is an explanatory diagram of an example of a mixture of a target subject and a non-target subject.

FIG. 15 is a functional block diagram for explaining an algorithm derivation method as a modification for removing a component of a non-target subject.

FIG. 16 is a block diagram of a computer-based system on which embodiments of the present system may be implemented.

### DESCRIPTION OF EMBODIMENTS

Hereinafter, embodiments according to the present technology will be described in the following order with reference to the accompanying drawings.
<1. Spectral camera>
<2. First embodiment>
(2-1. System configuration)
(2-2. Configuration of information processing device)
(2-3. Algorithm derivation method as embodiment)
(2-4. Image processing device as embodiment)
<3. Second embodiment>
(3-1. First example)
(3-2. Second example)
(3-3. Modification of second embodiment)
<4. Modification>
<5. Program>
<6. Notes>
<7. Summary of embodiments>
<8. Present technology>

### <1. Spectral Camera>

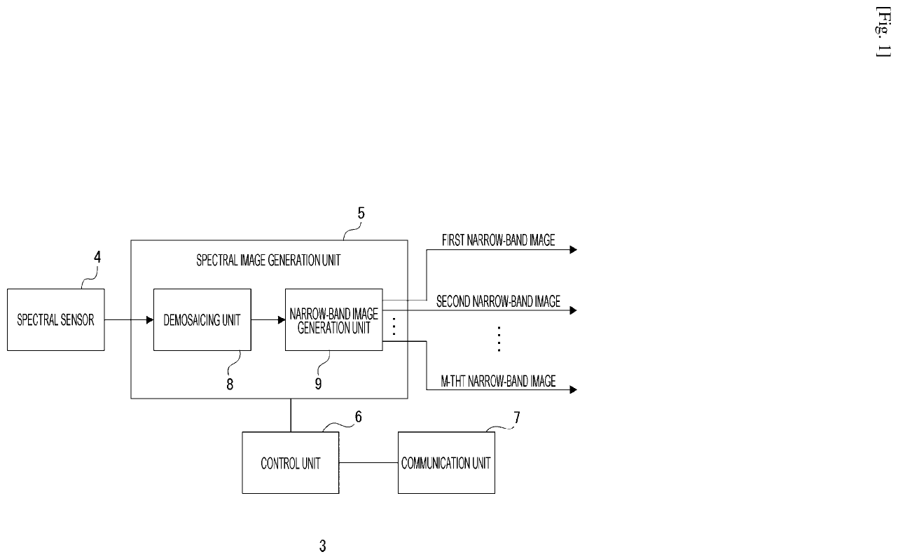

First, an example of a spectral camera targeted by the present technology will be described with reference to FIGS. 1 to 3.

FIG. 1 is a block diagram illustrating a schematic configuration example of a target spectral camera 3 according to an embodiment.

Here, the “spectral camera” means a camera including a spectral sensor as a light receiving sensor. The “spectral sensor” is a light receiving sensor for obtaining a plurality of narrow-band images that serves as wavelength characteristic analysis images for light from a subject.

As illustrated in FIG. 1, the spectral camera 3 includes a spectral sensor 4, a spectral image generation unit 5, a control unit 6, and a communication unit 7.

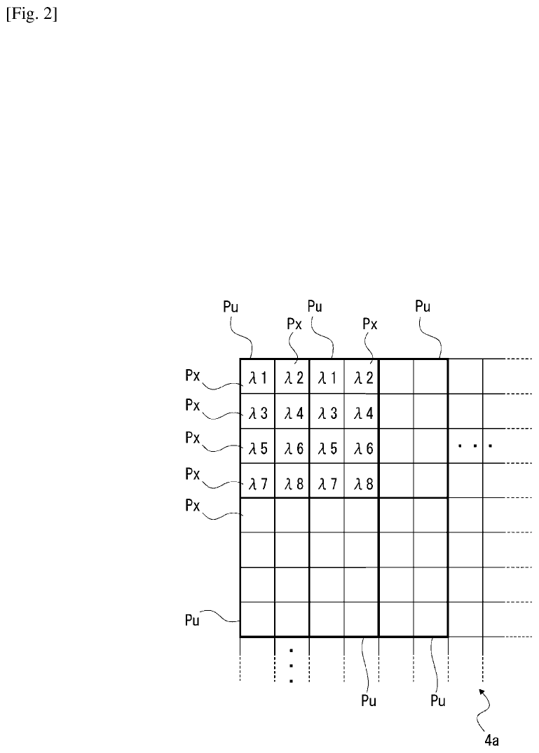

FIG. 2 is a diagram schematically illustrating a configuration example of a pixel array unit 4a included in the spectral sensor 4.

As illustrated in FIG. 2, in the pixel array unit 4a, a spectral pixel unit Pu in which a plurality of pixels Px each receiving light of a different wavelength band is twodimensionally arranged in a predetermined pattern is formed. The pixel array unit 4a includes a plurality of spectral pixel units Pu that is two-dimensionally arranged.

FIG. 2 illustrates an example in which the respective pixels Px of each spectral pixel unit Pu individually receive light of a total of eight wavelength bands of λ1 to λ8, in other words, an example in which the number of wavelength bands dividedly received in each spectral pixel unit Pu (hereinafter, referred to as “the number of light receiving wavelength channels”) is “eight”, but this is merely an example for description, and it is sufficient if the number of light receiving wavelength channels in the spectral pixel unit Pu is plural, and the number of light receiving wavelength channels in the spectral pixel unit Pu can be arbitrarily set.

Hereinafter, the number of light receiving wavelength channels in the spectral pixel unit Pu is referred to as “N”.

In FIG. 1, the spectral image generation unit 5 generates M narrow-band images on the basis of a raw image output from the spectral sensor 4. Here, it is assumed that “M>N”, and for example, M=41 for N=8.

The spectral image generation unit 5 includes a demosaicing unit 8 and a narrowband image generation unit 9. The demosaicing unit 8 executes demosaic processing on the raw image from the spectral sensor 4, and the narrow-band image generation unit 9 executes band-narrowing processing (linear matrix processing) based on respective wavelength band images for N channels obtained by the demosaic processing, thereby generating M narrow-band images from the N wavelength band images.

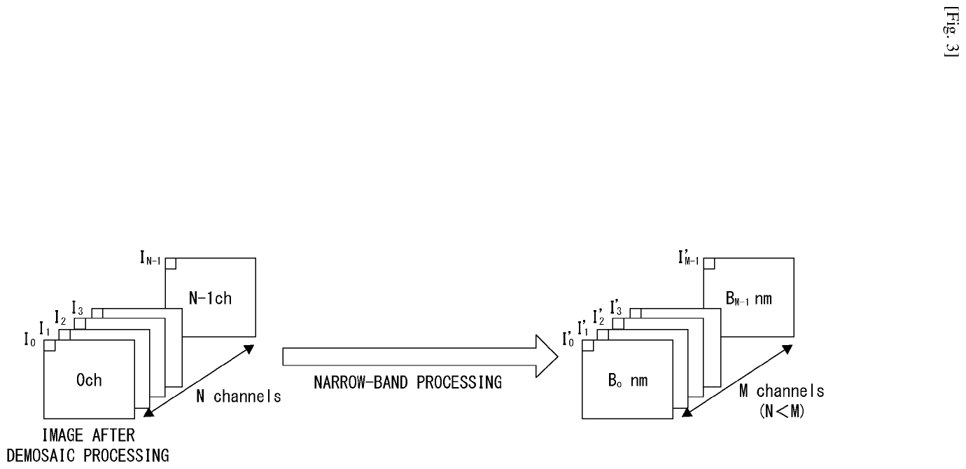

FIG. 3 is an explanatory diagram of the band-narrowing processing for obtaining M narrow-band images.

For example, matrix computation is performed for each pixel position on the basis of the wavelength band images for N channels obtained by the demosaic processing in the demosaicing unit 8 to obtain narrow-band images for M channels. The bandnarrowing processing is processing of obtaining pixel values (I′O to I'M-1 in FIG. 3) for M channels by matrix computation using pixel values (10 to IN-1 in FIG. 3) for N channels for each pixel position in order to convert the wavelength band images for N channels into narrow-band images for M channels as described above.

Here, the following [Equation 1] represents a computation expression for the bandnarrowing processing, in which R is a pixel value after the demosaicing processing, n (0 to N-1) is an input wavelength channel, C is a band-narrowing coefficient, B is an output pixel value by the band-narrowing processing, and m (0 to M-1) is an output wavelength channel.

$$\begin{matrix}[ Math . 1 ] & \\ B m = {\sum }_{n = 0}^{N - 1} ( R [ n ] * Cm [ n ] ) & [ Equation 1 ]\end{matrix}$$

That is, m=pixel value B0 of 0-th output wavelength channel=R[0]×C0[0]+R[1]×C0[1]+R[2]×C0[2]+, . . . ,+R[N−1]×C0[N−1], and m=pixel value B1 of first output wavelength channel=R[0]×C1[0]+R[1]×C1[1]+R[2]×C1[2]+, . . . ,+R[N−1]× C1[N−1].

Thereafter, similarly, the last m=pixel value BM−1 of M−1-th output wavelength channel=R[0]×CM−1 [0]+R[1]×CM−1 [1]+R[2]×CM−1 [2]+, . . . ,+R[N−1]×CM1 [N−1].

At this time, as the band-narrowing coefficient C, a total of N×M of C0[0] to C0[N−1] for obtaining the pixel value B0, C1[0] to C1[N−1] for obtaining the pixel value B1, . . . , and CM−1 [0] to CM−1 [N−1] for obtaining the pixel value BM−1 are used. In FIG. 1, the control unit 6 includes a microcomputer including, for example, a central processing unit (CPU), a read only memory (ROM), a random access memory (RAM), and the like, and performs overall control of the spectral camera 3 by the CPU executing processing based on, for example, a program stored in the ROM or a program loaded in the RAM.

The communication unit 7 performs wired or wireless data communication with an external device. For example, the communication unit 7 may be configured to perform wired data communication with an external device according to a predetermined wired communication standard such as a universal serial bus (USB) communication standard, wireless data communication with an external device according to a predetermined wireless communication standard such as a Bluetooth (registered trademark) communication standard, or wireless or wired data communication with an external device via a predetermined network such as the Internet.

The control unit 6 can transmit and receive data to and from an external device via the communication unit 7.

### 2. First Embodiment

### (2-1. System Configuration)

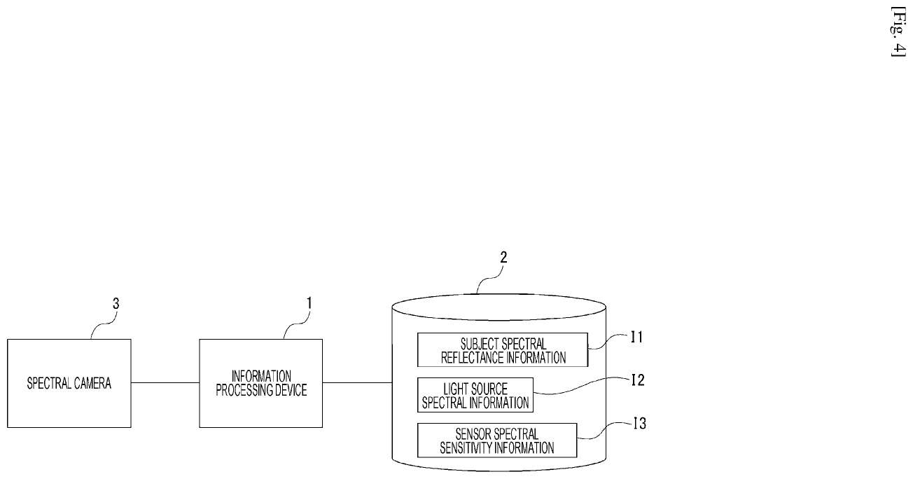

FIG. 4 is a diagram illustrating a configuration example of an algorithm derivation system including an information processing device 1 as an embodiment of the present technology.

As illustrated in FIG. 4, the algorithm derivation system as an embodiment includes the information processing device 1, a database 2, and the spectral camera 3.

The information processing device 1 is configured as a computer device and executes processing of deriving a computation algorithm (for example, the above-described band-narrowing coefficient C) of the band-narrowing processing for removing a light source component in the spectral camera 3 as described later.

The information processing device 1 in this example derives a computation algorithm for light source component removal on the basis of subject spectral reflectance information I1, light source spectral information 12, and sensor spectral sensitivity information I3 stored in a storage device as the database 2.

Here, the subject spectral reflectance information I1 is information indicating a spectral reflectance of a subject, that is, a reflectance for each wavelength. Further, the light source spectral information 12 is spectral information of a light source, that is, information indicating light intensity for each wavelength.

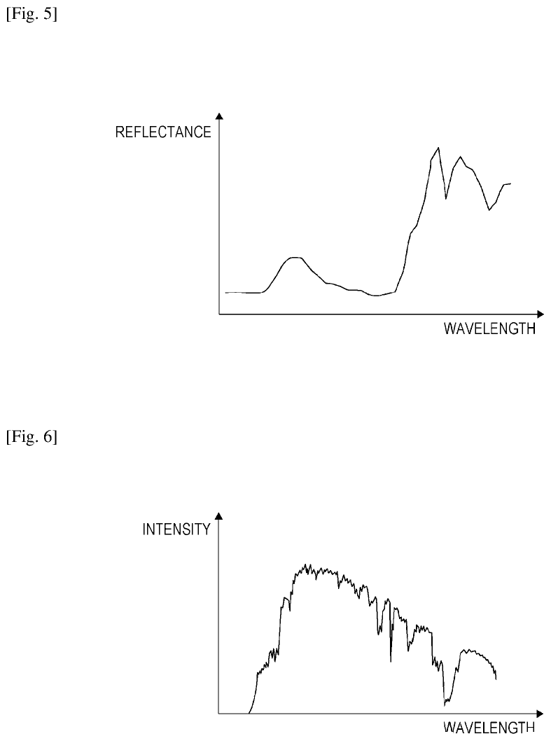

FIGS. 5 and 6 illustrate examples of the subject spectral reflectance information I1 and the light source spectral information 12, respectively.

In the present embodiment, spectral reflectance information of a subject selected in advance as a target is stored as the subject spectral reflectance information I1. Similarly, spectral information of a light source selected in advance as a target is stored as the light source spectral information 12.

In the database 2 of FIG. 4, the sensor spectral sensitivity information 13 is information indicating a sensitivity of the spectral sensor 4 for each wavelength. For example, information obtained by measurement for the spectral sensor 4 in advance using a dedicated measurement device or the like is stored in the database 2 as the sensor spectral sensitivity information I3.

Here, the spectral sensitivity of the spectral sensor 4 can be different for each individual spectral sensor 4. Therefore, in a case of deriving a computation algorithm suitable for each of a plurality of spectral cameras 3, the sensor spectral sensitivity information I3 measured for each spectral sensor 4 included in each of the spectral cameras 3 is stored in the database 2, and the spectral sensitivity information measured for the spectral sensor 4 included in the target spectral camera 3 is used in computation algorithm derivation processing as described later.

The information processing device 1 in this example also executes processing for setting the derived computation algorithm in the spectral camera 3. Specifically, the information processing device 1 in this example executes processing of transmitting the band-narrowing coefficient C derived by a derivation method as described later to the spectral camera 3 as the band-narrowing coefficient C used in the band-narrowing processing in the narrow-band image generation unit 9.

Note that it is not necessary for the information processing device 1 itself to transmit information of the computation algorithm derived by the information processing device 1 to the spectral camera 3. For example, it is conceivable that the information of the computation algorithm derived by the information processing device 1 is stored on a cloud, and the spectral camera 3 acquires the information of the computation algorithm from the cloud.

### (2-2. Configuration of Information Processing Device)

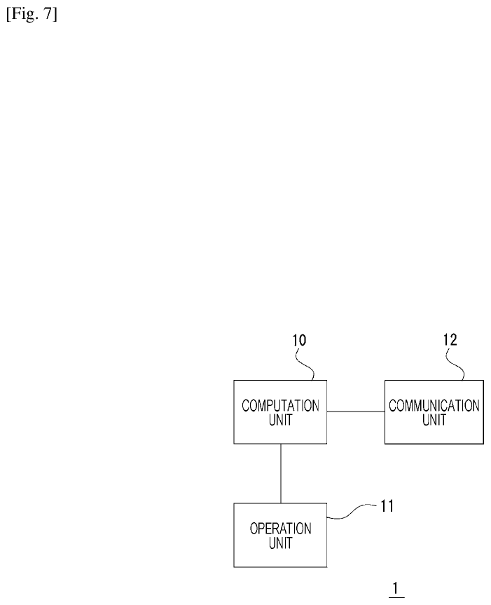

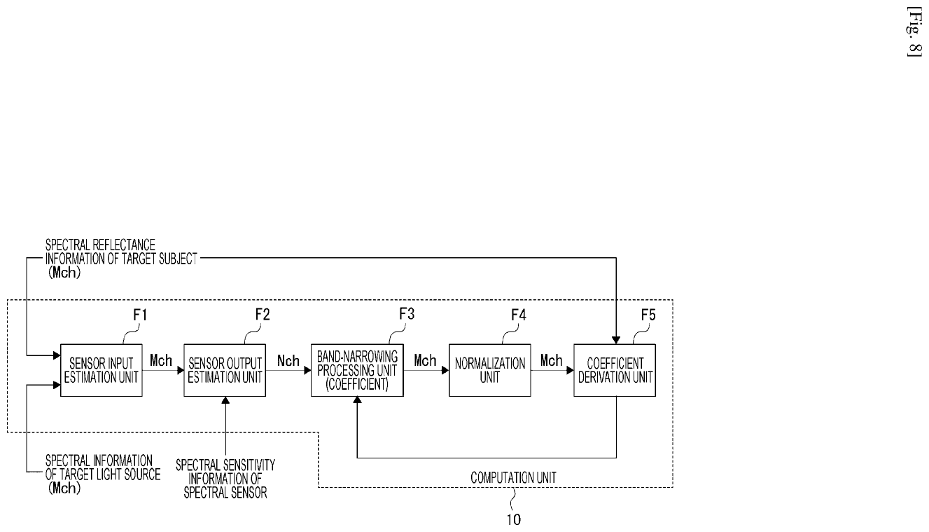

FIG. 7 is a block diagram illustrating a detailed configuration example of the information processing device 1.

As illustrated in FIG. 7, the information processing device 1 includes a computation unit 10, an operation unit 11, and a communication unit 12.

The computation unit 10 includes, for example, a microcomputer including a CPU, a ROM, a RAM, and the like, and performs predetermined computation and overall control of the information processing device 1 by the CPU executing processing based on a program stored in the ROM or a program loaded in the RAM.

The operation unit 11 includes various operators such as a keyboard, a mouse, a key, a dial, a touch panel, and a touch pad for a user to input an operation to the information processing device 1, and outputs an operation signal corresponding to an operation for the operator to the computation unit 10.

The computation unit 10 executes processing according to the operation signal. As a result, the processing in the information processing device 1 according to the user operation is implemented.

The communication unit 12 performs wired or wireless data communication with an external device (particularly, the database 2 or the spectral camera 3 illustrated in FIG. 4 in this example). Similarly to the communication unit 7 described above, the communication unit 12 may be configured to perform wired data communication with an external device according to a predetermined wired communication standard such as a USB communication standard, wireless data communication with an external device according to a predetermined wireless communication standard such as a Bluetooth communication standard, or wireless or wired data communication with an external device via a predetermined network such as the Internet.

The computation unit 10 can transmit and receive data to and from an external device via the communication unit 12.

### 2-3. Coefficient Derivation Method as Embodiment

Here, as described above, a method of estimating light source spectral information and dividing the estimated light source spectral information from spectral information after the band-narrowing processing (hereinafter, referred to as “post-band-narrowing spectral information”) has been adopted for removal of a light source component according to the related art. However, since there are many uncertain elements in estimation of the light source spectral information and an estimation error tends to occur, light source component removal accuracy tends to decrease in the method according to the related art.

Furthermore, since the intensity of many light sources including sunlight greatly changes for each wavelength (see FIG. 6 above), removal by division as described above may deteriorate accuracy of a spectrum at a wavelength at which the intensity of the light source is low.

Moreover, the spectrum of the light source is often different for each pixel, but it is difficult to estimate the spectral information of the light source for each pixel.

Here, in the method according to the related art, the light source component is appropriately removed for any combination of a subject and a light source regardless of the type of the subject and the light source. Therefore, in the method according to the related art, for the light source in the actual use environment of the spectral camera 3, the spectral information of the light source is estimated, and the estimated light source spectral information is divided from the post-band-narrowing spectral information obtained based on the output of the spectral sensor 4 to remove the light source component.

On the other hand, in the present embodiment, the following two methods different from the method according to the related art are adopted. That is, the first difference is that the light source spectral information is not divided from the post-band-narrowing spectral information as in the related art, but a function of removing a light source component is included in the band-narrowing processing. In other words, spectral information from which a light source component has been removed is obtained as the post-band-narrowing spectral information by deriving a computation algorithm of the band-narrowing processing capable of removing the light source component and executing the band-narrowing processing using the computation algorithm.

The second difference is that the present embodiment is not intended to be compatible with any combination of a subject and a light source as in the related art, but is intended to perform light source component removal suitable for some combinations of a subject and a light source by narrowing down target combinations of a subject and a light source to a partial range.

In the present embodiment, for a target subject and a target light source within the partial range as described above, the post-band-narrowing spectral information obtained by executing the band-narrowing processing is obtained by simulation using spectral reflectance information of the target subject and spectral information of the target light source. At this time, in order to remove the spectral information of the target light source by the band-narrowing processing, it is sufficient if a computation algorithm capable of reproducing a wavelength characteristic indicated by the spectral reflectance information of the target subject is derived as the computation algorithm of the band-narrowing processing. Therefore, in the present embodiment, a computation algorithm capable of minimizing an error between a wavelength characteristic indicated by the post-band-narrowing spectral information obtained by the above simulation and the wavelength characteristic indicated by the spectral reflectance information of the target subject is derived.

In this example, since it is assumed that the band-narrowing processing is executed by the matrix computation according to [Equation 1] described above, the band-narrowing coefficient C is derived as the computation algorithm described above.

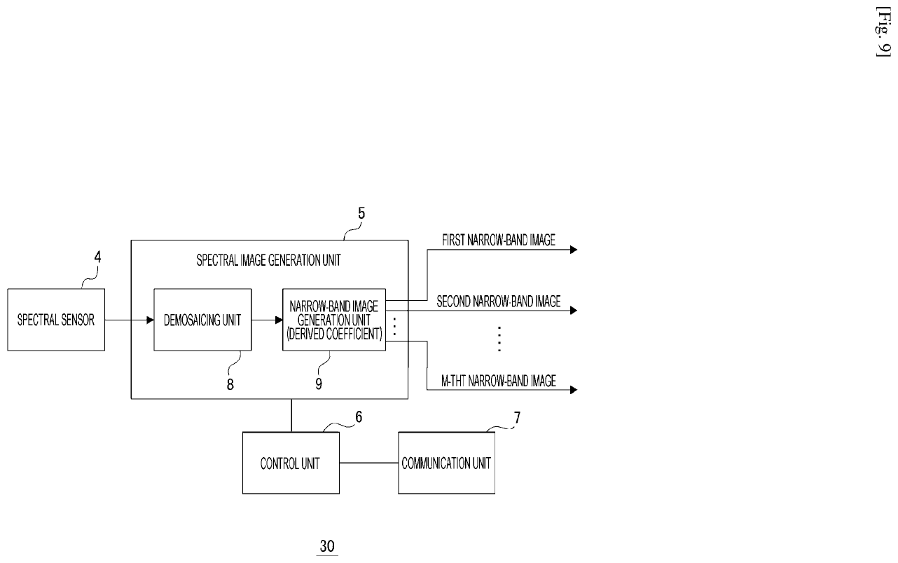

A specific example of an algorithm derivation method as an embodiment will be described with reference to FIG. 8.

FIG. 8 is a functional block diagram illustrating respective algorithm derivation functions of the computation unit 10 in the information processing device 1.

As illustrated in FIG. 8, the computation unit 10 includes a sensor input estimation unit F1, a sensor output estimation unit F2, a band-narrowing processing unit F3, a normalization unit F4, and a coefficient derivation unit F5 as respective functional units for coefficient derivation.

Here, the sensor input estimation unit F1 and the sensor output estimation unit F2 are examples of a “sensor output estimation processing unit” according to an embodiment of the present technology, and the band-narrowing processing unit F3, the normalization unit F4, and the coefficient derivation unit F5 are examples of a “derivation processing unit” according to an embodiment of the present technology.

The sensor input estimation unit F1 estimates a sensor input, which is spectral information of input light for the spectral sensor 4, on the basis of the spectral reflectance information of the target subject and the spectral information of the target light source.

Here, in this example, in order to avoid complication of description, it is assumed that there is only one target subject and one target light source. Here, as an application for performing subject analysis on the basis of a narrow-band image obtained by the spectral camera 3, for example, “lettuce”, “tomato (leaves of tomato)”, or the like can be exemplified as the target subject in a case where an application for analyzing vegetation of a plant such as a vegetable is assumed, and it is conceivable that the target subject is “human skin” in a case where an application for performing human skin condition analysis is assumed.

Furthermore, examples of the target light source can include “sun” and various “lighting devices” such as a fluorescent lamp, a white bulb, and a light emitting diode (LED).

As illustrated in FIG. 8, information based on a wavelength resolution of Mch (that is, information indicating a reflectance and a light intensity for each of M wavelength channels) is used for each of the spectral reflectance information of the target subject and the spectral information of the target light source.

The spectral reflectance information of the target subject and the spectral information of the target light source are stored as the subject spectral reflectance information I1 and the light source spectral information 12 in the database 2 illustrated in FIG. 4, respectively.

The sensor input estimation unit F1 acquires the spectral reflectance information of the target subject and the spectral information of the target light source stored as the subject spectral reflectance information I1 and the light source spectral information 12, respectively, in the database 2, and estimates the sensor input on the basis of the spectral reflectance information of the target subject and the spectral information of the target light source. For example, the sensor input is obtained by multiplying the light intensity for each wavelength channel indicated by the spectral information of the target light source by the reflectance of the corresponding wavelength channel indicated by the spectral reflectance information of the target subject.

Therefore, the sensor input in this example is obtained as information indicating the light intensity for each of M wavelength channels for the input light for the spectral sensor 4.

The sensor output estimation unit F2 estimates a sensor output which is spectral information output from the spectral sensor 4 according to the sensor input on the basis of the spectral sensitivity information of the spectral sensor 4 and the sensor input. Specifically, the sensor output estimation unit F2 acquires the spectral sensitivity information of the spectral sensor 4 stored as the sensor spectral sensitivity information 13 in the database 2, and estimates the sensor output (Nch) on the basis of the acquired spectral sensitivity information and the sensor input estimated by the sensor input estimation unit F1.

Here, the estimation of the sensor output involves wavelength conversion processing of reducing the number of wavelengths from M to N, contrary to the band-narrowing processing. In the wavelength conversion processing, a computation expression for wavelength conversion as in the above [Equation 1] is used. In this case, the spectral sensitivity information of the spectral sensor 4 obtained as information of a coefficient (a coefficient corresponding to the band-narrowing coefficient C in the computation expression for the band-narrowing processing) in the computation expression for wavelength conversion is stored as the sensor spectral sensitivity information 13 in the database 2, and the sensor output estimation unit F2 obtains the sensor output of Nch by executing the wavelength conversion processing on the sensor input by an Mchto-Nch wavelength conversion computation expression in which the coefficient is set. The band-narrowing processing unit F3 executes the band-narrowing processing of estimating spectral information for a larger number of wavelengths than the number of wavelengths of the sensor output on the basis of the sensor output. Specifically, the band-narrowing processing using the computation expression of [Equation 1] described above is executed on the sensor output estimated by the sensor output estimation unit F2, thereby obtaining post-band-narrowing spectral information corresponding to Mch.

The normalization unit F4 normalizes the post-band-narrowing spectral information obtained by the band-narrowing processing unit F3.

The coefficient derivation unit F5 obtains the band-narrowing coefficient C in such away as to minimize an error D between the wavelength characteristic indicated by the post-band-narrowing spectral information obtained by the band-narrowing processing unit F3 and the wavelength characteristic indicated by the spectral reflectance information of the target subject.

Here, as described above, in this example, the band-narrowing coefficient C that minimizes the error D between the wavelength characteristic indicated by the postband-narrowing spectral information and the wavelength characteristic indicated by the spectral reflectance information of the target subject is derived. However, while the post-band-narrowing spectral information is information indicating light intensity for each wavelength, the spectral reflectance information of the target subject is information indicating the reflectance for each wavelength, and the units thereof are different.

Therefore, the normalization unit F4 normalizes a value of the light intensity for each wavelength in the post-band-narrowing spectral information to a numerical value that can be compared with the reflectance (maximum value normalization).

Therefore, it is possible to obtain not an error between the post-band-narrowing spectral information itself and the spectral reflectance information of the target subject but an error between the normalized post-band-narrowing spectral information and the spectral reflectance information of the target subject. That is, it is possible to appropriately obtain the error D between the wavelength characteristic indicated by the postband-narrowing spectral information and the wavelength characteristic indicated by the spectral reflectance information of the target subject.

Note that, in this example, the post-band-narrowing spectral information is normalized, but it is also conceivable to normalize the spectral reflectance information of the target subject.

Here, various methods can be considered as a derivation processing method for the band-narrowing coefficient C in the coefficient derivation unit F5. For example, a method is conceivable in which, under the condition that a plurality of sets of bandnarrowing coefficients C as candidates is prepared, the band-narrowing processing unit F3 is caused to execute the band-narrowing processing while sequentially changing the sets of band-narrowing coefficients C set in the band-narrowing processing unit F3, the error D is obtained for each set of band-narrowing coefficients C, and the set of bandnarrowing coefficients C having the minimum error D is determined as the set of bandnarrowing coefficients C for removing the light source component.

Alternatively, it is also conceivable that the derivation processing for the bandnarrowing coefficient C is executed as processing using a least squares method, for example, processing using a regression analysis algorithm such as ridge regression or lasso regression.

In addition, it is also conceivable to derive the computation algorithm of the bandnarrowing processing having a light source component removal function by using an artificial intelligence (AI) technology. Specifically, an AI model that executes the band-narrowing processing having the light source component removal function is generated by machine learning.

In this case, in the machine learning of the AI model, input data for learning is a sensor output in a case where the spectral sensor 4 senses the target subject irradiated with light from the target light source, and training data is correct answer data from which a component of the target light source has been removed, specifically, for example, data obtained by normalizing the spectral reflectance information of the target subject to the spectral information. By performing such machine learning, the AI model can form the computation algorithm that minimizes the error between the wavelength characteristic indicated by the post-band-narrowing spectral information obtained by executing the band-narrowing processing based on the sensor output and the wavelength characteristic indicated by the spectral reflectance information of the target subject. That is, it is possible to derive the computation algorithm of the bandnarrowing processing capable of removing the component of the target light source.

With the algorithm derivation method as an embodiment as described above, the derivation processing for the computation algorithm of the band-narrowing processing is executed with the wavelength characteristic indicated by the spectral reflectance information of the target subject, which does not include the spectral information of the light source, as a target value. Therefore, as the spectral camera 3 executes the bandnarrowing processing by using the computation algorithm derived as described above, the spectral information from which the light source component has been removed can be obtained as the post-band-narrowing spectral information if the light source and the subject are of assumed target types. That is, if the band-narrowing processing is executed, the light source component is removed, so that it is not necessary to execute processing of estimating and removing the spectral information of the light source. As described above, with the algorithm derivation method as an embodiment, it is not necessary to adopt the method of estimating the spectral information of the light source and dividing the post-band-narrowing spectral information by the estimated spectral information of the light source according to the related art, and thus, the light source component removal accuracy can be improved.

In addition, with the algorithm derivation method as an embodiment, even in a case where the light source has a greatly different intensity depending on the wavelength, such as a case where the target light source is the sun as exemplified above, it is not necessary to execute processing of dividing the spectral information of the light source as in the related art, and thus, it is possible to remove the light source component with higher accuracy than in the related art.

Furthermore, with the algorithm derivation method as an embodiment, even in a case where the spectrum of the light source is different for each pixel, the computation algorithm for light source component removal can be derived for each pixel by the above-described derivation method.

Therefore, even in a case where the spectrum of the light source is different for each pixel, the spectrum of the light source can be removed with higher accuracy than in the related art.

Here, in the above description, an example in which only one type of subject and one type of light source are assumed as the target subject and the target light source has been described, but a plurality of target subjects and a plurality of target light sources can also be assumed.

For example, in a case where only the number of target subjects is plural, that is, in a case where light source component removal is appropriately performed only for a plurality of types of assumed subjects, it is sufficient if the band-narrowing coefficient C is derived as follows.

That is, the sensor input estimation unit F1 estimates the sensor input for each target subject on the basis of the spectral reflectance information of the plurality of target subjects and the spectral information of the target light source, the sensor output estimation unit F2 estimates the sensor output for each target subject on the basis of the sensor input for each target subject, and the band-narrowing processing unit F3 estimates the post-band-narrowing spectral information for each target subject on the basis of the sensor output for each target subject. Note that it goes without saying that the spectral reflectance information of the target spectral sensor 4 is used in the estimation of the sensor output in the sensor output estimation unit F2.

Then, the coefficient derivation unit F5 calculates the error D for each target subject on the basis of the post-band-narrowing spectral information for each target subject estimated by the band-narrowing processing unit F3 and the spectral reflectance information for each target subject, and obtains a set of band-narrowing coefficients C on the basis of the calculated error D for each target subject.

Here, in this example, the error D for each target subject is obtained by calculating a difference from the spectral reflectance information of each corresponding target subject for the post-band-narrowing spectral information for each target subject normalized by the normalization unit F4.

In this case, it is conceivable that the coefficient derivation unit F5 uses, as an evaluation index value, an integrated value of the errors D for the target subjects, such as a total value or an average value of the errors D for the target subjects, for example, and obtains a set of band-narrowing coefficients C in such a way as to minimize the evaluation index value.

Alternatively, in a case where there is a target subject to be prioritized among the plurality of assumed target subjects, it is also conceivable to obtain a set of bandnarrowing coefficients C in such a way that the error D of the target subject to be prioritized is preferentially reduced.

Furthermore, in a case where only the number of target light sources is plural, that is, in a case where light source component removal is appropriately performed only for a plurality of types of assumed light sources, it is sufficient if the band-narrowing coefficient C is derived as follows.

That is, the sensor input estimation unit F1 estimates the sensor input for each target light source on the basis of the spectral reflectance information of the target subject and the spectral information of the plurality of target light sources, the sensor output estimation unit F2 estimates the sensor output for each target light source on the basis of the sensor input for each target light source, and the band-narrowing processing unit F3 estimates the post-band-narrowing spectral information for each target light source on the basis of the sensor output for each target light source.

Then, the coefficient derivation unit F5 calculates the error D for each target light source on the basis of the post-band-narrowing spectral information for each target light source estimated by the band-narrowing processing unit F3 and the spectral reflectance information for the target subject, and obtains a set of band-narrowing coefficients C on the basis of the calculated error D for each target light source. In this example, the error D for each target light source is also obtained by calculating a difference from the spectral reflectance information of each corresponding target light source for the post-band-narrowing spectral information for each target light source normalized by the normalization unit F4.

The coefficient derivation unit F5 in this case uses, as the evaluation index value, an integrated value of the errors D for the target light sources, such as a total value or an average value of the errors D for the target light sources, for example, and obtains a set of band-narrowing coefficients C in such a way as to minimize the evaluation index value.

Alternatively, in a case where there is a target light source to be prioritized among the plurality of assumed target light sources, it is also conceivable to obtain a set of band-narrowing coefficients C in such a way that the error D of the target light source to be prioritized is preferentially reduced.

Moreover, it is also conceivable to assume a plurality of target subjects and a plurality of target light sources, that is, to appropriately perform light source component removal only for each combination of a plurality of types of assumed subjects and light sources.

In this case, the sensor input estimation unit F1 estimates the sensor input for each combination of the target subject and the target light source on the basis of the spectral reflectance information of the plurality of target subjects and spectral information of the plurality of target light sources, the sensor output estimation unit F2 estimates the sensor output for each combination on the basis of the sensor input for each combination, and the band-narrowing processing unit F3 estimates the postband-narrowing spectral information for each combination on the basis of the sensor output for each combination.

Then, the coefficient derivation unit F5 calculates the error D for each combination on the basis of the post-band-narrowing spectral information for each combination estimated by the band-narrowing processing unit F3 and the spectral reflectance information for each target subject, and obtains a set of band-narrowing coefficients C on the basis of the calculated error D for each combination.

In this example, the error D for each combination is also obtained by calculating a difference from the spectral reflectance information of each corresponding combination for the post-band-narrowing spectral information for each combination normalized by the normalization unit F4.

The coefficient derivation unit F5 in this case uses, as the evaluation index value, an integrated value of the errors D for the combinations, such as a total value or an average value of the errors D for the combinations, for example, and obtains a set of band-narrowing coefficients C in such a way as to minimize the evaluation index value.

Alternatively, in a case where there is a combination to be prioritized among the plurality of assumed combinations of the target subject and the target light source, it is also conceivable to obtain a set of band-narrowing coefficients C in such a way that the error D of the combination to be prioritized is preferentially reduced.

### 2-4. Image Processing Device as Embodiment

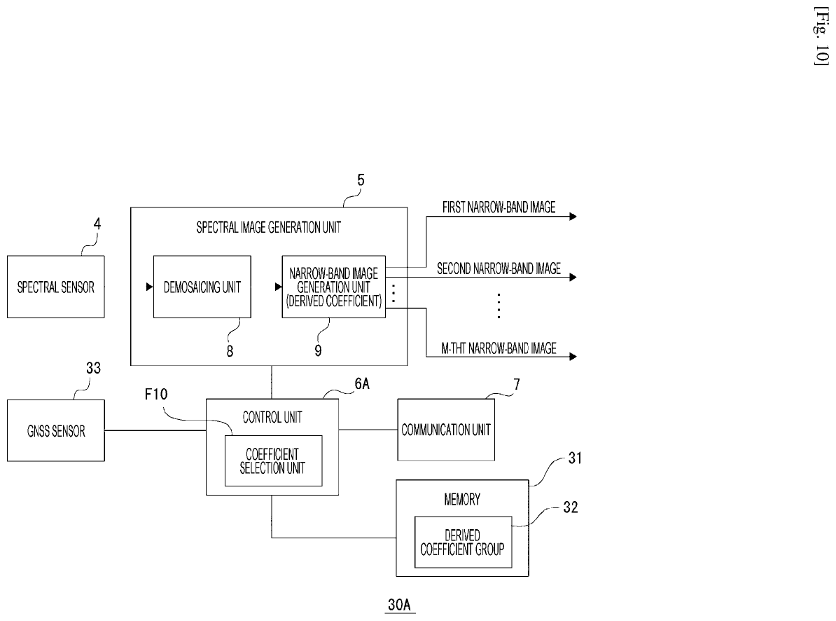

FIG. 9 is a block diagram illustrating a schematic configuration example of a spectral camera 30 as an image processing device according to an embodiment of the present technology.

Note that, in the following description, the same reference numerals are given to portions similar to those already described, and description thereof will be omitted.

The spectral camera 30 according to an embodiment is similar to the spectral camera 3 illustrated in FIG. 1 in that the spectral sensor 4, the spectral image generation unit 5, the control unit 6, and the communication unit 7 are included, but is different from the spectral camera 3 in that the computation algorithm of the band-narrowing processing obtained by the information processing device 1 using the above-described algorithm derivation method as an embodiment, specifically, the band-narrowing coefficient C, is set in the narrow-band image generation unit 9.

That is, it can be said that the spectral camera 30 as an embodiment includes the following spectral image generation unit 5. That is, the information processing device 1 includes the spectral image generation unit 5 that executes the band-narrowing processing based on the output of the spectral sensor 4 by using the computation algorithm obtained by the algorithm derivation method as an embodiment to generate narrow-band images for a larger number of wavelengths than the number of output wavelengths of the spectral sensor.

As understood from the above description, the computation algorithm of the bandnarrowing processing obtained by the information processing device 1 using the algorithm derivation method as an embodiment is a coefficient that can obtain spectral information from which a light source component has been removed without executing processing of removing the light source component by executing the band-narrowing processing using the computation algorithm if the light source and the subject are of assumed target types.

Therefore, with the spectral camera 30 as an embodiment that executes the bandnarrowing processing using such a computation algorithm, it is possible to improve the light source component removal accuracy.

Note that, in a case of using the AI model, the spectral image generation unit 5 is configured to execute the band-narrowing processing using the AI model derived by the algorithm derivation method as an embodiment.

### 3. Second Embodiment

Next, a second embodiment will be described.

The second embodiment is a countermeasure example in a case where the light source is a variable spectral light source.

The variable spectral light source mentioned here means a light source whose spectral information can change with time, and an example thereof may be the sun.

A solar altitude of the sun changes with the lapse of time, and the light source spectral information changes with a change in solar altitude.

In the second embodiment, for a case where the spectral information of the light source can change with time as described above, an information processing device 1 executes processing of deriving a corresponding computation algorithm for each spectral information assumed as the spectral information of the variable spectral light source.

Hereinafter, spectral information assumed as the spectral information of the variable spectral light source is referred to as “variable light source spectral information”. For example, in a case where the variable spectral light source is the sun, the variable light source spectral information corresponds to spectral information of the sun at each different solar altitude.

Specifically, in the information processing device 1 according to the second embodiment, a band-narrowing coefficient C for each variable light source spectral information is derived as follows.

That is, a sensor input estimation unit F1 estimates a sensor input for each variable light source spectral information on the basis of spectral reflectance information of a target subject and a plurality of pieces of variable light source spectral information, a sensor output estimation unit F2 estimates a sensor output for each variable light source spectral information on the basis of the sensor input for each variable light source spectral information, and a band-narrowing processing unit F3 estimates postband-narrowing spectral information for each variable light source spectral information on the basis of the sensor output for each variable light source spectral information.

Then, a coefficient derivation unit F5 calculates an error D for each variable light source spectral information based on the post-band-narrowing spectral information for each variable light source spectral information estimated by the band-narrowing processing unit F3 and the spectral reflectance information of the target subject, and obtains the band-narrowing coefficient C that minimizes the error D for each variable light source spectral information.

In this example, the error D for each variable light source spectral information is obtained by calculating a difference from the spectral reflectance information of each corresponding variable light source spectral information for the post-band-narrowing spectral information for each variable light source spectral information normalized by the normalization unit F4.

In the second embodiment, the spectral camera 30 stores the band-narrowing coefficient C for each variable light source spectral information derived by the information processing device 1 as described above.

Then, the spectral camera 30 in the second embodiment estimates a state of the variable spectral light source in the use environment, and executes processing of selecting, as the band-narrowing coefficient C to be used for the band-narrowing processing in the spectral image generation unit 5, a band-narrowing coefficient C corresponding to the estimated state of the variable spectral light source from the bandnarrowing coefficients C for the pieces of variable light source spectral information obtained by the information processing device 1.

As a result, it is possible to switch and use the band-narrowing coefficient C in such away as to follow a spectral information change of the variable spectral light source, fora case where the light source in the use environment of the spectral camera 30 is the variable spectral light source.

Therefore, it is possible to improve the light source component removal accuracy under a camera use environment in which the variable spectral light source is used as the light source.

Here, various methods can be considered for estimating the state of the variable spectral light source.

Hereinafter, a first example and a second example will be described as examples of the method for estimating the state of the variable spectral light source by taking a case where the variable spectral light source is the sun as an example.

### 3-1. First Example

FIG. 10 is a block diagram illustrating a schematic configuration example of a spectral camera 30A as a first example according to the second embodiment. In the first example, processing of estimating a solar altitude on the basis of information regarding a current position and a date and time is executed as processing of estimating the state of the variable spectral light source.

As illustrated in FIG. 10, the spectral camera 30A is different from the spectral camera 30 in that a control unit 6A is provided instead of a control unit 6, and a memory 31 and a global navigation satellite system (GNSS) sensor 33 are added.

The GNSS sensor 33 is an example of a position detection device that detects the current position of the spectral camera 30A.

In the spectral camera 30A, a set of band-narrowing coefficients C for each variable light source spectral information derived by the information processing device 1 using the coefficient derivation method as the second embodiment described above is stored as a derived coefficient group 32 in the memory 31.

In the derived coefficient group 32 in this case, an identifier of a corresponding solar altitude is associated with each set of band-narrowing coefficients C.

The control unit 6A functions as a coefficient selection unit F10 that selects a bandnarrowing coefficient C to be used in the band-narrowing processing in the narrowband image generation unit 9 from the derived coefficient group 32.

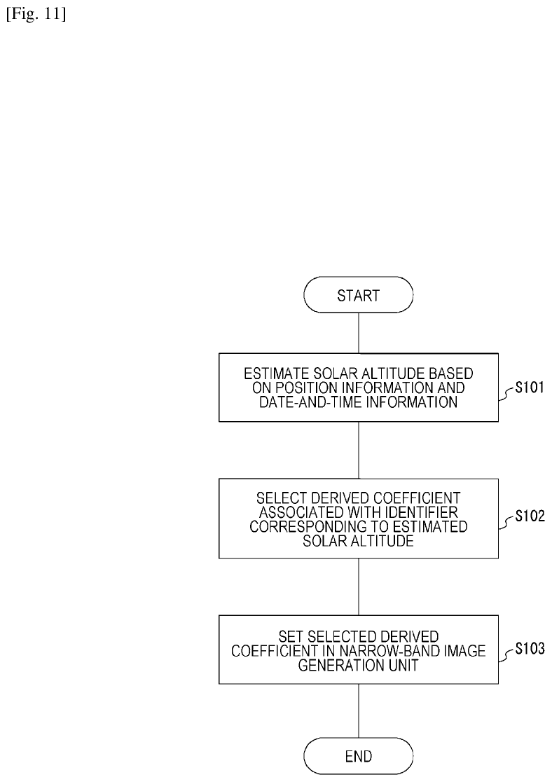

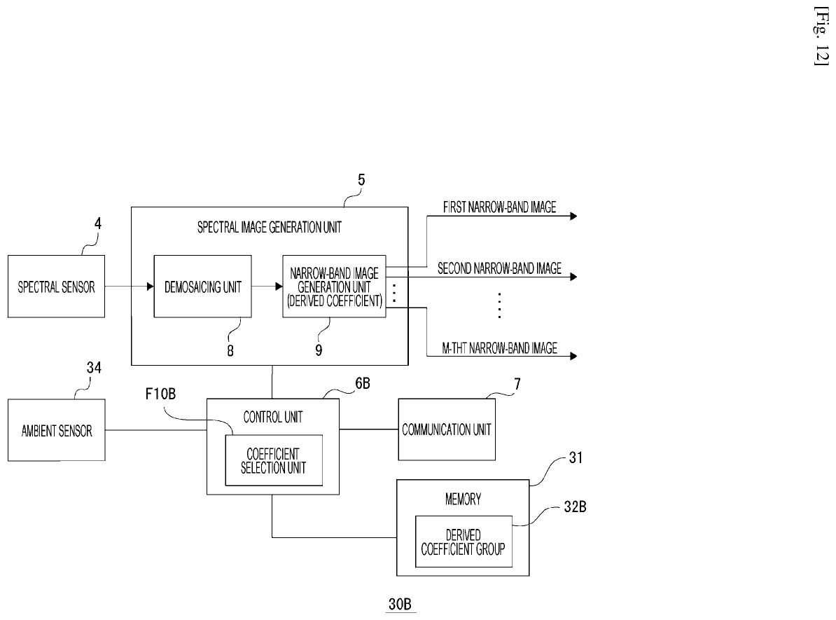

FIG. 11 is a flowchart of coefficient selection processing executed by the coefficient selection unit F10.

As illustrated in FIG. 11, the coefficient selection unit F10 estimates the solar altitude at the current position on the basis of the position information, that is, the current position information of the spectral camera 30A detected by the GNSS sensor 33 and the current date and time information (step S101). Then, the coefficient selection unit F10 selects, from the derived coefficient group 32, the band-narrowing coefficient C (derived coefficient) associated with the identifier corresponding to the estimated solar altitude (step S102). Furthermore, the coefficient selection unit F10 executes processing of setting the selected derived coefficient in the narrow-band image generation unit 9 (step S103).

With the coefficient selection unit F10 as described above, it is possible to select an appropriate band-narrowing coefficient C corresponding to the variable light source spectral information of the sun, for a case where the variable spectral light source is the sun. Since it is not necessary to estimate the spectral information of the sun in selecting an appropriate band-narrowing coefficient C corresponding to the variable light source spectral information of the sun, an ambient sensor for measuring (estimating) spectral information of sunlight can be omitted.

### 3-2. Second Example

FIG. 12 is a block diagram illustrating a schematic configuration example of a spectral camera 30B as a second example according to the second embodiment.

In the second example, processing of estimating the spectral information of the sun on the basis of an output of the ambient sensor is executed as the processing of estimating the state of the variable spectral light source.

As illustrated in FIG. 12, the spectral camera 30B is different from the spectral camera 30A in that a control unit 6B is provided instead of the control unit 6A and an ambient sensor 34 is provided instead of the GNSS sensor 33.

The ambient sensor 34 is provided as, for example, a spectral sensor whose imaging direction is an upward direction.

In the spectral camera 30B, a memory 31 stores a derived coefficient group 32B instead of the derived coefficient group 32. In the derived coefficient group 32B, corresponding solar spectral information is associated with each set of band-narrowing coefficients C derived by the information processing device 1 of the second embodiment.

The control unit 6B is different from the control unit 6A in that the control unit 6B includes a coefficient selection unit F10B instead of the coefficient selection unit F10A.

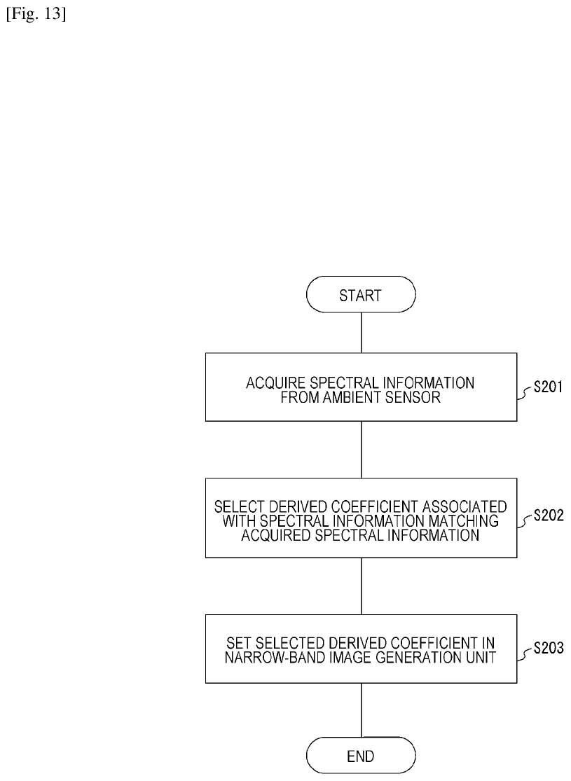

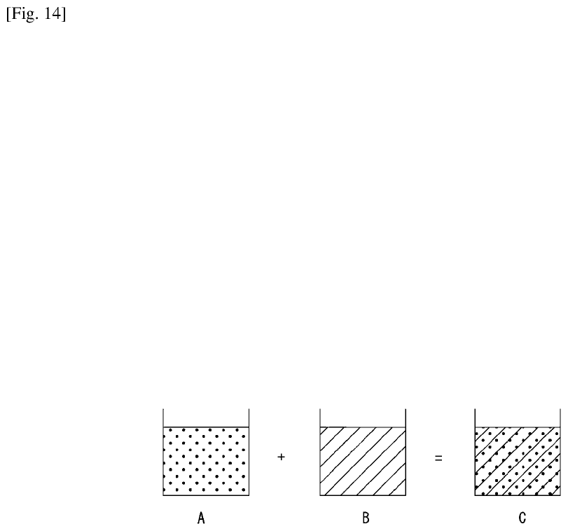

FIG. 13 is a flowchart of coefficient selection processing executed by the coefficient selection unit F10B.

As illustrated in FIG. 13, the coefficient selection unit F10B first acquires spectral information from the ambient sensor 34 (step S201). That is, spectral information of the sun (spectral information of the sun in the current use environment) is estimated on the basis of an output of the ambient sensor 34.

Then, the coefficient selection unit F10B selects, from the derived coefficient group 32B, a band-narrowing coefficient C (derived coefficient) associated with spectral information matching the acquired spectral information (step S202).

Furthermore, the coefficient selection unit F10B executes processing of setting the selected derived coefficient in a narrow-band image generation unit 9 (step S203).

With the coefficient selection unit F10B as described above, it is possible to select an appropriate band-narrowing coefficient C according to the spectral information of the variable spectral light source, for a case where the light source in the use environment of the spectral camera 30B is the variable spectral light source such as the sun. Since it is not necessary to detect the current position in selecting an appropriate bandnarrowing coefficient C according to the spectral information of the variable spectral light source, a position detection device such as a GNSS sensor can be omitted.

### 3-3. Modification of Second Embodiment

Note that, in the above description, regarding the derivation of the band-narrowing coefficient C in the information processing device 1, a coefficient derivation example in a case where only one target subject and one target light source are assumed has been described. However, also in the second embodiment, coefficient derivation assuming a case where any one or both of the number of target subjects and the number of target light sources are plural can be performed.

Furthermore, in the above description, a countermeasure in a case where the spectral information of the light source changes with time even if the light source itself is the same has been described, but a camera use environment in which the light source itself changes can also be assumed, and it is also conceivable to take a countermeasure in that case.

Coefficient derivation corresponding to a case where the light source itself changes may be performed as follows.

That is, the sensor input estimation unit F1 estimates the sensor input for each target light source on the basis of the spectral reflectance information of the target subject and the spectral information of the plurality of target light sources, the sensor output estimation unit F2 estimates the sensor output for each target light source on the basis of the sensor input for each target light source, and the band-narrowing processing unit F3 estimates the post-band-narrowing spectral information for each target light source on the basis of the sensor output for each target light source.

Then, the coefficient derivation unit F5 calculates the error D for each target light source on the basis of the post-band-narrowing spectral information for each target light source estimated by the band-narrowing processing unit F3 and the spectral reflectance information for the target subject, and obtains a band-narrowing coefficient C that minimizes the error D for each target light source.

In this case, the spectral camera stores the band-narrowing coefficient C for each target light source obtained as described above. Then, the spectral camera in this case executes processing of determining a light source in the current use environment and processing of selecting a band-narrowing coefficient C corresponding to the determined light source from the stored band-narrowing coefficients C and setting the selected band-narrowing coefficient C in the narrow-band image generation unit 9.

By obtaining the coefficient for each target light source as described above, it is possible to switch and use the coefficient in such a way as to cause the spectral camera to follow the change in light source for a case where the light source changes in the use environment of the spectral camera.

Therefore, it is possible to improve the light source component removal accuracy under the camera use environment in which the light source changes.

Note that, also in the second embodiment, it is conceivable to execute the bandnarrowing processing including the function of removing the light source component by using the AI model. In this case, it is sufficient if the AI model for each variable light source spectral information is derived by machine learning. In machine learning for each AI model, each sensor output generated on the basis of different variable light source spectral information are used as input data for learning, but information of a wavelength characteristic indicated by spectral reflectance information of a target subject (for example, information normalized to spectral information) is used as training data.

### <4. Modification>

Note that the embodiments are not limited to the specific examples described above, and may be configured as various modifications.

For example, by applying an algorithm derivation method as an embodiment, it is conceivable to remove not only the light source component but also a component of a subject B from spectral information of a mixture C of a subject A and the subject B, and to obtain appropriate spectral information for the subject A.

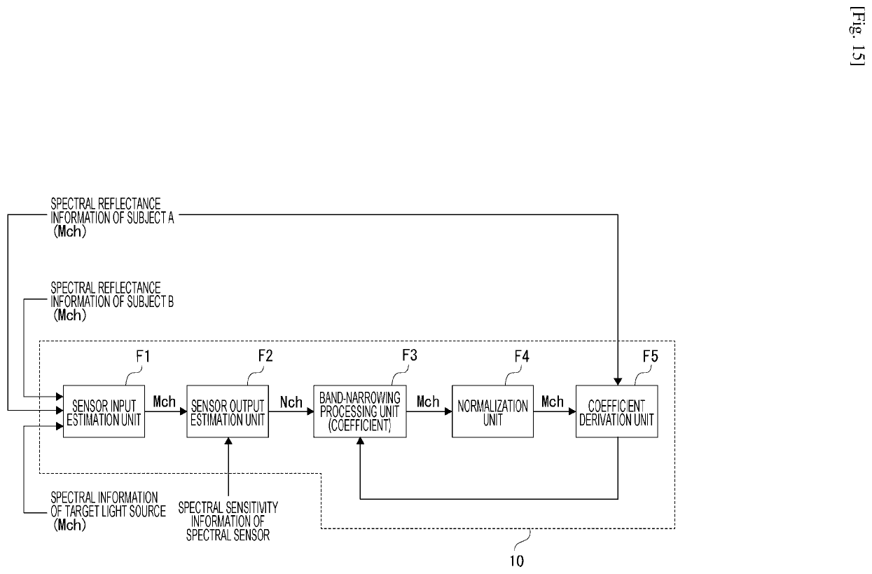

FIG. 14 is an explanatory diagram of an example of the mixture C.

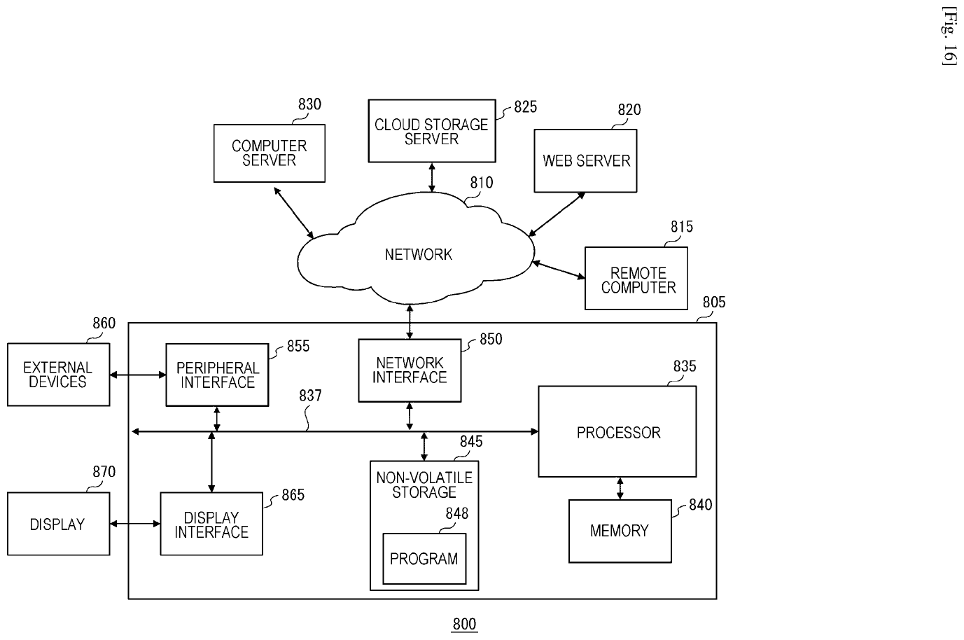

For example, in a case where the subjects liquids, a liquid obtained by mixing the liquid as the subject A and the liquid as the subject B corresponds to the mixture C. In this case, as illustrated in FIG. 15, the information processing device 1 derives a band-narrowing coefficient C for removing the light source component and the component of the subject B.

That is, the sensor input estimation unit F1 in this case estimates a sensor input for the mixture C of the subject A and the subject B on the basis of spectral reflectance information of the subject A (target subject), spectral reflectance information of the subject B (non-target subject different from the target subject), and spectral information of the target light source. In addition, the sensor output estimation unit F2 in this case estimates a sensor output for the mixture C on the basis of the sensor input for the mixture C, and the band-narrowing processing unit F3 estimates postband-narrowing spectral information for the mixture C on the basis of the sensor output for the mixture C.

Then, the coefficient derivation unit F5 in this case obtains a band-narrowing coefficient C in such a way as to minimize an error between a wavelength characteristic (the post-band-narrowing spectral information for the mixture C normalized by the normalization unit F4 in this example) indicated by the post-band-narrowing spectral information for the mixture C estimated by the band-narrowing processing unit F3 and a wavelength characteristic indicated by the spectral reflectance information of the target subject.

According to the above algorithm derivation method, derivation of the bandnarrowing coefficient C is performed with the wavelength characteristic of the spectral reflectance information of only the target subject as a target value. Therefore, in a case where the spectral camera 30 images a mixture of a target subject and a non-target subject, it is possible to obtain a computation algorithm of band-narrowing processing capable of obtaining post-band-narrowing spectral information from which spectral information of the non-target subject has been removed.

Note that, also in the present modification, a plurality of target subjects and a plurality of target light sources may be assumed. For example, it is conceivable to assume a plurality of subjects belonging to vegetables, a plurality of lighting fixtures having a relatively slight difference in illumination light, and the like. Furthermore, it is conceivable that a plurality of non-target subjects is provided.

Further, also in the present modification, it is conceivable to execute the bandnarrowing processing by using the AI model. In this case, machine learning for the AI model may be performed by using the sensor output for the mixture C as input data for learning and using information of the wavelength characteristic indicated by the spectral reflectance information of the target subject (for example, information normalized to the spectral information) as training data.

Here, in the above description, an example has been described in which the information processing device 1 acquires the subject spectral reflectance information I1, the light source spectral information 12, and the sensor spectral sensitivity information 13 used for deriving the computation algorithm from the external database 2. However, it is also conceivable to adopt a configuration in which a storage device that stores the subject spectral reflectance information I1, the light source spectral information 12, and the sensor spectral sensitivity information 13 is provided in the information processing device 1.

Furthermore, in the above description, the device form of the spectral camera including the spectral sensor 4 has been exemplified as the device form of the image processing device according to an embodiment of the present technology, but the image processing device according to an embodiment of the present technology may also have a device form not including the spectral sensor 4 or the demosaicing unit 8. For example, it is conceivable that the spectral sensor 4 is provided in an external device, and an output from the spectral sensor 4 is input to execute the demosaic processing and band-narrowing processing. Alternatively, a device form is conceivable in which the spectral sensor 4 and the demosaicing unit 8 are provided in an external device, and the band-narrowing processing is executed on a spectral image subjected to the demosaic processing output from the external device.

### <5. Program>

Here, as an embodiment, it is possible to consider a program for causing a CPU, a digital signal processor (DSP), or the like, or a device including the CPU, the digital signal processor (DSP), or the like, to implement the functions as the sensor input estimation unit F1, the sensor output estimation unit F2, the band-narrowing processing unit F3, the coefficient derivation unit F5, and the like described with reference to FIG. 8, FIG. 15, and the like.

That is, the program according to an embodiment is a program readable by a computer device, and causes the computer device to implement the functions of estimating, on the basis of spectral reflectance information of a target subject and spectral information of a target light source, a sensor output that is output spectral information of a spectral sensor in a case where the spectral sensor has sensed the target subject irradiated with light from the target light source, and obtaining, as a computation algorithm of band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject. With such a program, the functions as the sensor input estimation unit F1, the sensor output estimation unit F2, the band-narrowing processing unit F3, and the coefficient derivation unit F5 described above can be implemented in a device as the information processing device 1 or the like.

The program as described above can be recorded in advance in a hard disc drive (HDD) as a recording medium built in a device such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program can be installed from the removable recording medium into a personal computer or the like, or can be downloaded from a download site via a network such as a local area network (LAN) or the Internet.

In addition, such a program is suitable for a wide range of provision of the algorithm derivation method as an embodiment. For example, by downloading the program to a mobile terminal device such as a personal computer, a portable information processing device, a mobile phone, a game device, a video device, a personal digital assistant (PDA), or the like, the personal computer or the like can be caused to function as a device that implements the algorithm derivation method of the present disclosure.

### <6. Notes>

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least lossless encoding and decoding using inverse orthogonal transforms in an image processing system.

FIG. 16 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A nonexhaustive list of more specific examples of the computer readable storage medium includes each of the following (and appropriate combinations): flexible disk, hard disk, solid-state drive (SSD), random access memory (RAM), read-only memory (ROM), erasable programmable readonly memory (EPROM or Flash), static random access memory (SRAM), compact disc (CD or CDROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 16 is a functional block diagram illustrating a networked system 800 of one or more networked computers and servers. In an embodiment, the hardware and software environment illustrated in FIG. 16 may provide an exemplary platform for implementation of the software and/or methods according to the present disclosure.

Referring to FIG. 16, a networked system 800 may include, but is not limited to, computer 805, network 810, remote computer 815, web server 820, cloud storage server 825 and compute server 830. In some embodiments, multiple instances of one or more of the functional blocks illustrated in FIG. 16 may be employed.

Additional detail of computer 805 is shown in FIG. 16. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM).

Non-volatile storage 845 may include one or more of the following: flexible disk, hard disk, solid-state drive (SSD), read-only memory (ROM), erasable programmable readonly memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computerreadable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

Combination of connections and protocols that support communications between two or more computers and related devices.

Obviously, numerous modifications and variations of the present invention are possible in light of the above teachings. It is therefore to be understood that within the scope of the appended claims, the invention may be practiced otherwise than as specifically described herein.

### 7. Summary of Embodiments

As described above, the information processing device (1) as an embodiment includes: the sensor output estimation processing unit (the sensor input estimation unit F1 and the sensor output estimation unit F2) that estimates, on the basis of spectral reflectance information of a target subject and spectral information of a target light source, a sensor output that is output spectral information of the spectral sensor (4) in a case where the spectral sensor has sensed the target subject irradiated with light from the target light source; and the derivation processing unit (the band-narrowing processing unit F4 and the coefficient derivation unit F5) that obtains, as a computation algorithm of band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

With the configuration described above, the computation algorithm of the bandnarrowing processing is derived with the wavelength characteristic indicated by the spectral reflectance information of the target subject, which does not include the spectral information of the light source, as a target value. Therefore, as the spectral camera executes the band-narrowing processing by using the computation algorithm derived as described above, spectral information from which a light source component has been removed can be obtained as the post-band-narrowing spectral information if the light source and the subject are of assumed target types. That is, if the bandnarrowing processing is executed, the light source component is removed, so that it is not necessary to execute processing of estimating and removing the spectral information of the light source.

It is not necessary to adopt the method of estimating the spectral information of the light source and dividing the post-band-narrowing spectral information by the estimated spectral information of the light source according to the related art, and thus, the light source component removal accuracy can be improved.

Furthermore, in the information processing device as an embodiment, the bandnarrowing processing is executed by matrix computation based on the sensor output, and the derivation processing unit obtains a coefficient of the matrix computation in such a way as to minimize the error between the wavelength characteristic indicated by the post-band-narrowing spectral information and the wavelength characteristic indicated by the spectral reflectance information of the target subject (see FIG. 8). Therefore, it is possible to obtain a coefficient for removing a light source component for a case where the band-narrowing processing is executed by matrix computation based on the sensor output.

Furthermore, in the information processing device as an embodiment, a plurality of the target subjects is provided, the sensor output estimation processing unit estimates the sensor output for each target subject on the basis of spectral reflectance information of the plurality of target subjects and the spectral information of the target light source, and the derivation processing unit estimates the post-band-narrowing spectral information for each target subject on the basis of the sensor output for each target subject, calculates the error for each target subject on the basis of the estimated postband-narrowing spectral information for each target subject and the spectral reflectance information for each target subject, and obtains a set of the coefficients on the basis of the calculated error for each target subject.

Therefore, it is possible to obtain a set of coefficients capable of appropriately removing the light source component for a plurality of types of subjects without being specialized only for one type of subject. That is, by executing the band-narrowing processing using the set of coefficients on the spectral camera side, it is possible to perform appropriate light source component removal for a plurality of types of subjects.

Furthermore, in the information processing device as an embodiment, a plurality of the target light sources is provided, the sensor output estimation processing unit estimates the sensor output for each target light source on the basis of the spectral reflectance information of the target subject and spectral information of the plurality of target light sources, and the derivation processing unit estimates the postband-narrowing spectral information for each target light source on the basis of the sensor output for each target light source, calculates the error for each target light source on the basis of the estimated post-band-narrowing spectral information for each target light source and the spectral reflectance information of the target subject, and obtains a set of the coefficients on the basis of the calculated error for each target light source.

Therefore, it is possible to obtain a set of coefficients capable of appropriately removing the light source component for a plurality of types of light sources without being specialized only for one type of light source. That is, by executing the bandnarrowing processing using the set of coefficients on the spectral camera side, it is possible to perform appropriate light source component removal for a plurality of types of light sources.

Furthermore, in the information processing device as an embodiment, a plurality of the target subjects and a plurality of the target light sources are provided, the sensor output estimation processing unit estimates the sensor output for each combination of the target subject and the target light source on the basis of spectral reflectance information of the plurality of target subjects and spectral information of the plurality of target light sources, and the derivation processing unit estimates the postband-narrowing spectral information for each combination on the basis of the sensor output for each combination, calculates the error for each combination on the basis of the estimated post-band-narrowing spectral information for each combination and the spectral reflectance information for each target subject, and obtains a set of the coefficients on the basis of the calculated error for each combination.

Therefore, it is possible to obtain a set of coefficients capable of appropriately removing the light source component for a plurality of types of combinations of a subject and a light source without being specialized only for one type of combination of a subject and a light source. That is, by executing the band-narrowing processing using the set of coefficients on the spectral camera side, it is possible to perform appropriate light source component removal for a plurality of types of combinations of a subject and a light source.

Furthermore, in the information processing device as an embodiment, the target light source is a variable spectral light source whose spectral information changes with time, and in a case where spectral information assumed as the spectral information of the variable spectral light source is variable light source spectral information, the sensor output estimation processing unit estimates the sensor output for each variable light source spectral information on the basis of the spectral reflectance information of the target subject and a plurality of pieces of the variable light source spectral information, and the derivation processing unit estimates the post-band-narrowing spectral information for each variable light source spectral information on the basis of the sensor output for each variable light source spectral information, calculates the error for each variable light source spectral information on the basis of the estimated postband-narrowing spectral information for each variable light source spectral information and the spectral reflectance information of the target subject, and obtains the computation algorithm that minimizes the error for each variable light source spectral information (see the second embodiment).

By obtaining the computation algorithm for each variable light source spectral information as described above, it is possible to switch and use the computation algorithm in such a way as to cause the spectral camera to follow the change in spectral information of the variable spectral light source, for a case where the light source in the use environment of the spectral camera is the variable spectral light source. Therefore, it is possible to improve the light source component removal accuracy under a camera use environment in which the variable spectral light source is used as the light source.

Furthermore, in the information processing device as an embodiment, the variable spectral light source includes the sun, and the variable light source spectral information includes spectral information that changes depending on a solar altitude.

Therefore, it is possible to improve the light source component removal accuracy under a camera use environment in which the sun is the light source.

Furthermore, in the information processing device as an embodiment, the sensor output estimation processing unit estimates the sensor output for a mixture of the target subject and a non-target subject different from the target subject on the basis of the spectral reflectance information of the target subject, spectral reflectance information of the non-target subject, and the spectral information of the target light source, and the derivation processing unit estimates the post-band-narrowing spectral information for the mixture on the basis of the sensor output for the mixture, and obtains the computation algorithm that minimizes an error between a wavelength characteristic indicated by the estimated post-band-narrowing spectral information for the mixture and the wavelength characteristic indicated by the spectral reflectance information of the target subject (see FIGS. 14 and 15).

With the above configuration, derivation of the computation algorithm is performed using the wavelength characteristic of the spectral reflectance information of only the target subject as a target value. Therefore, in a case where the spectral camera images a mixture of a target subject and a non-target subject, it is possible to obtain a computation algorithm capable of obtaining post-band-narrowing spectral information from which spectral information of the non-target subject has been removed.

An information processing method as an embodiment is an information processing method executed by an information processing device, the information processing method including estimating, on the basis of spectral reflectance information of a target subject and spectral information of a target light source, a sensor output that is output spectral information of a spectral sensor in a case where the spectral sensor has sensed the target subject irradiated with light from the target light source, and obtaining, as a computation algorithm of band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

Also with such an information processing method, functions and effects similar to functions and effects of the information processing device as the embodiment described above can be obtained.

Furthermore, the program as an embodiment is a program readable by a computer device, and causes the computer device to implement the functions of estimating, on the basis of spectral reflectance information of a target subject and spectral information of a target light source, a sensor output that is output spectral information of a spectral sensor in a case where the spectral sensor has sensed the target subject irradiated with light from the target light source, and obtaining, as a computation algorithm of bandnarrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

With such a program, the above-described information processing device as an embodiment can be achieved.

The image processing device (the spectral cameras 30, 30A, and 30B) as an embodiment includes: the spectral image generation unit (5) that generates a narrow-band image for a larger number of wavelengths than the number of output wavelengths of the spectral sensor (4) by executing band-narrowing processing based on an output of the spectral sensor using a computation algorithm obtained by the information processing device (1) including the sensor output estimation processing unit that estimates, on the basis of spectral reflectance information of a target subject and spectral information of a target light source, a sensor output that is output spectral information of the spectral sensor in a case where the spectral sensor has sensed the target subject irradiated with light from the target light source, and the derivation processing unit that obtains, as the computation algorithm of the band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by postband-narrowing spectral information obtained by executing the band-narrowing processing based on the sensor output and a wavelength characteristic indicated by the spectral reflectance information of the target subject.

The computation algorithm obtained by the information processing device as described above is a computation algorithm that can obtain spectral information from which alight source component has been removed without executing processing of removing the light source component by executing the band-narrowing processing using the computation algorithm if the light source and the subject are of assumed target types. Therefore, with the image processing device as an embodiment that executes the bandnarrowing processing using such a computation algorithm, it is possible to improve the light source component removal accuracy.

Furthermore, in the image processing device (the spectral cameras 30A and 30B) as an embodiment, the target light source is a variable spectral light source whose spectral information changes with time, and in a case where spectral information assumed as the spectral information of the variable spectral light source is variable light source spectral information, the information processing device obtains the computation algorithm that minimizes the error for each variable light source spectral information on the basis of a plurality of pieces of the variable light source spectral information, and includes a selection processing unit (the coefficient selection units F10 and F10B) that estimates a state of the variable spectral light source and selects, as a computation algorithm to be used for the band-narrowing processing in the spectral image generation unit, the computation algorithm corresponding to the estimated state of the variable spectral light source from the computation algorithms for the plurality of pieces of variable light source spectral information obtained by the information processing device (see the second embodiment).

As a result, it is possible to switch and use the computation algorithm in such a way as to follow a spectral information change of the variable spectral light source, for a case where the light source in the use environment of the spectral camera is the variable spectral light source.

Therefore, it is possible to improve the light source component removal accuracy under a camera use environment in which the variable spectral light source is used as the light source.

Furthermore, in the image processing device (the spectral camera 30A) as an embodiment, the variable spectral light source includes the sun, and the selection processing unit (the coefficient selection unit F10) executes processing of estimating a solar altitude on the basis of information regarding a current position and a date and time as processing of estimating the state of the variable spectral light source.

Therefore, it is possible to select an appropriate computation algorithm corresponding to the variable light source spectral information of the sun, for a case where the variable spectral light source is the sun. Since it is not necessary to estimate the spectral information of the sun in selecting an appropriate computation algorithm corresponding to the variable light source spectral information of the sun, the ambient sensor can be omitted.

Furthermore, in the image processing device (the spectral camera 30B) as an embodiment, the selection processing unit (coefficient selection unit F10B) executes processing of estimating the spectral information of the variable spectral light source on the basis of an output of the ambient sensor as processing of estimating the state of the variable spectral light source.

Therefore, it is possible to select an appropriate computation algorithm corresponding to the spectral information of the variable spectral light source in the use environment of the spectral camera. Since it is not necessary to detect the current position in selecting an appropriate computation algorithm corresponding to the spectral information of the variable spectral light source, the position detection device such as a GNSS sensor can be omitted.

An image processing method as an embodiment executed by an image processing device includes: generating a narrow-band image for a larger number of wavelengths than the number of output wavelengths of a spectral sensor by executing bandnarrowing processing based on an output of the spectral sensor using a computation algorithm obtained by an information processing device including a sensor output estimation processing unit that estimates, on a basis of spectral reflectance information of a target subject and spectral information of a target light source, a sensor output that is output spectral information of the spectral sensor in a case where the spectral sensor has sensed the target subject irradiated with light from the target light source, and a derivation processing unit that obtains, as the computation algorithm of the bandnarrowing processing that is processing of estimating spectral information for a larger number of wavelengths than the number of output wavelengths of the spectral sensor on a basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

With such an image processing method, it is possible to obtain functions and effects similar to those of the image processing device as the above-described embodiment.

Note that the effects described in the present specification are merely examples and

are not limited, and other effects may be provided.

### <8. Present Technology>

The present technology can also adopt the following configurations.

(1)

An information processing device including:
a sensor output estimation processing unit that estimates, on the basis of spectral reflectance information of a target subject and spectral information of a target light source, a sensor output that is output spectral information of a spectral sensor in a case where the spectral sensor has sensed the target subject irradiated with light from the target light source; and
a derivation processing unit that obtains, as a computation algorithm of bandnarrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.
   (2)

The information processing device according to (1), in which the band-narrowing processing is executed by matrix computation based on the sensor output, and the derivation processing unit obtains a coefficient of the matrix computation in such away as to minimize the error between the wavelength characteristic indicated by the post-band-narrowing spectral information and the wavelength characteristic indicated by the spectral reflectance information of the target subject.

(3)

The information processing device according to (2), in which a plurality of the target subjects is provided, the sensor output estimation processing unit estimates the sensor output for each target subject on the basis of spectral reflectance information of the plurality of target subjects and the spectral information of the target light source, and the derivation processing unit estimates the post-band-narrowing spectral information for each target subject on the basis of the sensor output for each target subject, calculates the error for each target subject on the basis of the estimated postband-narrowing spectral information for each target subject and the spectral reflectance information for each target subject, and obtains a set of the coefficients on the basis of the calculated error for each target subject.

(4)

The information processing device according to (2), in which a plurality of the target light sources is provided,
the sensor output estimation processing unit estimates the sensor output for each target light source on the basis of the spectral reflectance information of the target subject and spectral information of the plurality of target light sources, and
the derivation processing unit estimates the post-band-narrowing spectral information for each target light source on the basis of the sensor output for each target light source, calculates the error for each target light source on the basis of the estimated post-band-narrowing spectral information for each target light source and the spectral reflectance information of the target subject, and obtains a set of the coefficients on the basis of the calculated error for each target light source.
   (5)

The information processing device according to (2), in which a plurality of the target subjects and a plurality of the target light sources are provided,
the sensor output estimation processing unit estimates the sensor output for each combination of the target subject and the target light source on the basis of spectral reflectance information of the plurality of target subjects and spectral information of the plurality of target light sources, and
the derivation processing unit estimates the post-band-narrowing spectral information for each combination on the basis of the sensor output for each combination, calculates the error for each combination on the basis of the estimated post-band-narrowing spectral information for each combination and the spectral reflectance information for each target subject, and obtains a set of the coefficients on the basis of the calculated error for each combination.
   (6)

The information processing device according to any one of (1) to (3), in which the target light source is a variable spectral light source whose spectral information changes with time, and
in a case where spectral information assumed as the spectral information of the variable spectral light source is variable light source spectral information, the sensor output estimation processing unit estimates the sensor output for each variable light source spectral information on the basis of the spectral reflectance information of the target subject and a plurality of pieces of the variable light source spectral information, and
the derivation processing unit estimates the post-band-narrowing spectral information for each variable light source spectral information on the basis of the sensor output for each variable light source spectral information, calculates the error for each variable light source spectral information on the basis of the estimated post-band-narrowing spectral information for each variable light source spectral information and the spectral reflectance information of the target subject, and obtains the computation algorithm that minimizes the error for each variable light source spectral information.
   (7)

The information processing device according to (6), in which the variable spectral light source includes the sun, and the variable light source spectral information includes spectral information that changes depending on a solar altitude.

(8)

The information processing device according to any one of (1) to (5), in which the sensor output estimation processing unit estimates the sensor output for a mixture of the target subject and a non-target subject different from the target subject on the basis of the spectral reflectance information of the target subject, spectral reflectance information of the non-target subject, and the spectral information of the target light source, and
the derivation processing unit estimates the post-band-narrowing spectral information for the mixture on the basis of the sensor output for the mixture, and obtains the computation algorithm that minimizes an error between a wavelength characteristic indicated by the estimated post-band-narrowing spectral information for the mixture and the wavelength characteristic indicated by the spectral reflectance information of the target subject.
   (9)

An information processing method executed by an information processing device, the information processing method including:
estimating, on the basis of spectral reflectance information of a target subject and spectral information of a target light source, a sensor output that is output spectral information of a spectral sensor in a case where the spectral sensor has sensed the target subject irradiated with light from the target light source; and
obtaining, as a computation algorithm of band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.
   (10)

A program readable by a computer device, the program causing the computer device to execute functions of:
estimating, on the basis of spectral reflectance information of a target subject and spectral information of a target light source, a sensor output that is output spectral information of a spectral sensor in a case where the spectral sensor has sensed the target subject irradiated with light from the target light source; and
obtaining, as a computation algorithm of band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.
   (11)

An image processing device including:
a spectral image generation unit that generates a narrow-band image for a larger number of wavelengths than the number of output wavelengths of a spectral sensor by executing band-narrowing processing based on an output of the spectral sensor using a computation algorithm obtained by an information processing device including a sensor output estimation processing unit that estimates, on the basis of spectral reflectance information of a target subject and spectral information of a target light source, a sensor output that is output spectral information of the spectral sensor in a case where the spectral sensor has sensed the target subject irradiated with light from the target light source, and a derivation processing unit that obtains, as the computation algorithm of the band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.
   (12)

The image processing device according to (11), in which the target light source is a variable spectral light source whose spectral information changes with time, and in a case where spectral information assumed as the spectral information of the variable spectral light source is variable light source spectral information, the information processing device obtains the computation algorithm that minimizes the error for each variable light source spectral information on the basis of a plurality of pieces of the variable light source spectral information, and includes a selection processing unit that estimates a state of the variable spectral light source and selects, as a computation algorithm to be used for the band-narrowing processing in the spectral image generation unit, the computation algorithm corresponding to the estimated state of the variable spectral light source from the computation algorithms for the plurality of pieces of variable light source spectral information obtained by the information processing device.

(13)

The image processing device according to (12), in which the variable spectral light source includes the sun, and
the selection processing unit executes processing of estimating a solar altitude on the basis of information regarding a current position and a date and time as processing of estimating the state of the variable spectral light source.
   (14)

The image processing device according to (12), in which the selection processing unit executes processing of estimating the spectral information of the variable spectral light source on the basis of an output of an ambient sensor as processing of estimating the state of the variable spectral light source.

(15)

An image processing method executed by an image processing device, the image processing method including:
generating a narrow-band image for a larger number of wavelengths than the number of output wavelengths of a spectral sensor by executing band-narrowing processing based on an output of the spectral sensor using a computation algorithm obtained by an information processing device including a sensor output estimation processing unit that estimates, on the basis of spectral reflectance information of a target subject and spectral information of a target light source, a sensor output that is output spectral information of the spectral sensor in a case where the spectral sensor has sensed the target subject irradiated with light from the target light source, and a derivation processing unit that obtains, as the computation algorithm of the band-narrowing processing that is processing of estimating spectral information for a larger number of wavelengths than the number of output wavelengths of the spectral sensor on the basis of the output spectral information of the spectral sensor, a computation algorithm that minimizes an error between a wavelength characteristic indicated by postband-narrowing spectral information obtained by executing the band-narrowing processing based on the sensor output and a wavelength characteristic indicated by the spectral reflectance information of the target subject.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Information processing device
2 Database
3 Spectral camera
4 Spectral sensor
4a Pixel array unit
5 Spectral image generation unit
6, 6A, 6B Control unit
7 Communication unit
8 Demosaicing unit
9 Narrow-band image generation unit
Px Pixel
Pu Spectral pixel unit
I1 Subject spectral reflectance information
I2 Light source spectral information
I3 Sensor spectral sensitivity information
10 Computation unit
11 Operation unit
12 Communication unit
F1 Sensor input estimation unit
F2 Sensor output estimation unit
F3 Band-narrowing processing unit
F4 Normalization unit
F5 Coefficient derivation unit
D Error
30, 30A, 30B Spectral camera
31 Memory
32,32B Derived coefficient group
33 GNSS sensor
F10, F10B Coefficient selection unit
34 Ambient sensor

1. An information processing device comprising:
a sensor output estimation processing unit that estimates, on a basis of spectral reflectance information of a target subject and spectral information of a target light source, a sensor output that is output spectral information of a spectral sensor in a case where the spectral sensor has sensed the target subject irradiated with light from the target light source; and
a derivation processing unit that obtains, as a computation algorithm of band-narrowing processing that is processing of estimating spectral information for a larger number of wavelengths than the number of output wavelengths of the spectral sensor on a basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

2. The information processing device according to claim 1, wherein the band-narrowing processing is executed by matrix computation based on the sensor output, and
the derivation processing unit obtains a coefficient of the matrix computation in such a way as to minimize the error between the wavelength characteristic indicated by the post-band-narrowing spectral information and the wavelength characteristic indicated by the spectral reflectance information of the target subject.

3. The information processing device according to claim 2, wherein a plurality of the target subjects is provided,
the sensor output estimation processing unit estimates the sensor output for each target subject on a basis of spectral reflectance information of the plurality of target subjects and the spectral information of the target light source, and
the derivation processing unit estimates the post-band-narrowing spectral information for each target subject on a basis of the sensor output for each target subject, calculates the error for each target subject on a basis of the estimated post-band-narrowing spectral information for each target subject and the spectral reflectance information for each target subject, and obtains a set of the coefficients on a basis of the calculated error for each target subject.

4. The information processing device according to claim 2, wherein a plurality of the target light sources is provided,
the sensor output estimation processing unit estimates the sensor output for each target light source on a basis of the spectral reflectance information of the target subject and spectral information of the plurality of target light sources, and
the derivation processing unit estimates the post-band-narrowing spectral information for each target light source on a basis of the sensor output for each target light source, calculates the error for each target light source on a basis of the estimated post-band-narrowing spectral information for each target light source and the spectral reflectance information of the target subject, and obtains a set of the coefficients on abasis of the calculated error for each target light source.

5. The information processing device according to claim 2, wherein a plurality of the target subjects and a plurality of the target light sources are provided,
the sensor output estimation processing unit estimates the sensor output for each combination of the target subject and the target light source on a basis of spectral reflectance information of the plurality of target subjects and spectral information of the plurality of target light sources, and
the derivation processing unit estimates the post-band-narrowing spectral information for each combination on a basis of the sensor output for each combination, calculates the error for each combination on a basis of the estimated post-band-narrowing spectral information for each combination and the spectral reflectance information for each target subject, and obtains a set of the coefficients on a basis of the calculated error for each combination.

6. The information processing device according to claim 1, wherein the target light source is a variable spectral light source whose spectral information changes with time, and
in a case where spectral information assumed as the spectral information of the variable spectral light source is variable light source spectral information, the sensor output estimation processing unit estimates the sensor output for each variable light source spectral information on a basis of the spectral reflectance information of the target subject and a plurality of pieces of the variable light source spectral information, and
the derivation processing unit estimates the post-band-narrowing spectral information for each variable light source spectral information on a basis of the sensor output for each variable light source spectral information, calculates the error for each variable light source spectral information on a basis of the estimated post-band-narrowing spectral information for each variable light source spectral information and the spectral reflectance information of the target subject, and obtains the computation algorithm that minimizes the error for each variable light source spectral information.

7. The information processing device according to claim 6, wherein the variable spectral light source includes the sun, and the variable light source spectral information includes spectral information that changes depending on a solar altitude.

8. The information processing device according to claim 1, wherein the sensor output estimation processing unit estimates the sensor output for a mixture of the target subject and a non-target subject different from the target subject on a basis of the spectral reflectance information of the target subject, spectral reflectance information of the non-target subject, and the spectral information of the target light source, and
the derivation processing unit estimates the post-band-narrowing spectral information for the mixture on a basis of the sensor output for the mixture, and obtains the computation algorithm that minimizes an error between a wavelength characteristic indicated by the estimated post-band-narrowing spectral information for the mixture and the wavelength characteristic indicated by the spectral reflectance information of the target subject.

9. An information processing method executed by an information processing device, the information processing method comprising:
estimating, on a basis of spectral reflectance information of a target subject and spectral information of a target light source, a sensor output that is output spectral information of a spectral sensor in a case where the spectral sensor has sensed the target subject irradiated with light from the target light source; and
obtaining, as a computation algorithm of band-narrowing processing that is processing of estimating spectral information for a larger number of wavelengths than the number of output wavelengths of the spectral sensor on a basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

10. A program readable by a computer device, the program causing the computer device to execute functions of:
estimating, on a basis of spectral reflectance information of a target subject and spectral information of a target light source, a sensor output that is output spectral information of a spectral sensor in a case where the spectral sensor has sensed the target subject irradiated with light from the target light source; and
obtaining, as a computation algorithm of band-narrowing processing that is processing of estimating spectral information for a larger number of wavelengths than the number of output wavelengths of the spectral sensor on a basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

11. An image processing device comprising:
a spectral image generation unit that generates a narrow-band image for a larger number of wavelengths than the number of output wavelengths of a spectral sensor by executing band-narrowing processing based on an output of the spectral sensor using a computation algorithm obtained by an information processing device including a sensor output estimation processing unit that estimates, on abasis of spectral reflectance information of a target subject and spectral information of a target light source, a sensor output that is output spectral information of the spectral sensor in a case where the spectral sensor has sensed the target subject irradiated with light from the target light source, and a derivation processing unit that obtains, as the computation algorithm of the band-narrowing processing that is processing of estimating spectral information for a larger number of wavelengths than the number of output wavelengths of the spectral sensor on a basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.

12. The image processing device according to claim 11, wherein the target light source is a variable spectral light source whose spectral information changes with time, and
in a case where spectral information assumed as the spectral information of the variable spectral light source is variable light source spectral information, the information processing device obtains the computation algorithm that minimizes the error for each variable light source spectral information on a basis of a plurality of pieces of the variable light source spectral information, and includes a selection processing unit that estimates a state of the variable spectral light source and selects, as a computation algorithm to be used for the bandnarrowing processing in the spectral image generation unit, the computation algorithm corresponding to the estimated state of the variable spectral light source from the computation algorithms for the plurality of pieces of variable light source spectral information obtained by the information processing device.

13. The image processing device according to claim 12, wherein the variable spectral light source includes the sun, and
the selection processing unit executes processing of estimating a solar altitude on a basis of information regarding a current position and a date and time as processing of estimating the state of the variable spectral light source.

14. The image processing device according to claim 12, wherein the selection processing unit executes processing of estimating the spectral information of the variable spectral light source on a basis of an output of an ambient sensor as processing of estimating the state of the variable spectral light source.

15. An image processing method executed by an image processing device, the image processing method comprising:
generating a narrow-band image for a larger number of wavelengths than the number of output wavelengths of a spectral sensor by executing band-narrowing processing based on an output of the spectral sensor using a computation algorithm obtained by an information processing device including a sensor output estimation processing unit that estimates, on a basis of spectral reflectance information of a target subject and spectral information of a target light source, a sensor output that is output spectral information of the spectral sensor in a case where the spectral sensor has sensed the target subject irradiated with light from the target light source, and a derivation processing unit that obtains, as the computation algorithm of the band-narrowing processing that is processing of estimating spectral information for a larger number of wavelengths than the number of output wavelengths of the spectral sensor on a basis of the output spectral information of the spectral sensor, a computation algorithm that minimizes an error between a wavelength characteristic indicated by post-band-narrowing spectral information obtained by executing the band-narrowing processing based on the sensor output and a wavelength characteristic indicated by the spectral reflectance information of the target subject.
